(19) United States
(12) Patent Application Publication
(10) Pub. No.: US 2008/0052642 A1
(43) Pub. Date: Feb. 28, 2008

(54) PERSONALIZED, DYNAMIC, APPLICATION SELECTION INTERFACE

(76) Inventors: David Frederick Champion, Durham, NC (US); Timothy Andreas Meserth, Durham, NC (US); Mark E. Molander, Cary, NC (US); Patrick Gabor Nyeste, Raleigh, NC (US); Jeffrey John Smith, Raleigh, NC (US); David Thomas Windell, Raleigh, NC (US)

Correspondence Address: Kunzler & McKenzie, 8 EAST BROADWAY, SUITE 600, SALT LAKE CITY, UT, 84111, US

(21) Appl. No.: 11/466,985

(22) Filed: Aug. 24, 2006

(51) Int. Cl. G06F 9/00

(52) U.S. Cl. 715/862; 715/779; 715/856

(57) ABSTRACT

One embodiment of an apparatus for interacting with open applications in a graphical-user-interface (GUI) environment includes an initiation module to initiate, at the prompting of a user, an application selection interface mimicking the standard taskbar of an operating system GUI. The application selection interface displays applications and files currently open on a computer system of the user. A customization module enables the user to hide, according to the user's preferences, specific files, applications, groups of files, menus, toolbars, and the like that are displayed on the application selection interface, while leaving displayed other files, applications, groups of files, menus, toolbars, and the like.

### BACKGROUND OF THE INVENTION

1. Field of the Invention

This invention relates to apparatus and methods for interacting and interfacing with open applications in a graphical-user-interface environment.

2. Description of the Related Art

In the WINDOWS operating system, the “taskbar” is the primary tool used to launch and monitor applications. Other desktop environments, such as those used with the LINUX and MAC operating systems, provide similar features and elements to those offered by the WINDOWS taskbar.

In WINDOWS, the taskbar is by default located at the bottom of the screen and includes the Start menu, Quick Launch bar, Taskbar buttons, and Notification area which is also known as the system tray. Each time a file or application is opened, WINDOWS generates a window and a corresponding button in the taskbar. These buttons enable the windows to be maximized, minimized, or made active, and provide for convenient monitoring of open applications. However, the taskbar often becomes crowded with taskbar buttons when working with multiple applications and files simultaneously. For this reason, Microsoft introduced taskbar grouping in WINDOWS XP in an attempt to alleviate this problem. This feature groups several taskbar buttons of the same application into a single button once a specified number of buttons, normally three, has been reached.

When a Windows user desires to change the application displayed on his or her screen, the user must either direct the mouse pointer to the bottom of the screen to select a button on the taskbar or press alt+tab and then tab through the open applications until reaching a desired application. Rapidly switching between multiple applications may be arduous and time-consuming, requiring multiple mouse strokes and clicks or multiple key presses. Furthermore, when taskbar buttons are combined into a single button, a user is unable to select a desired file without first directing the pointer to the bottom of the screen, selecting the desired button, and scrolling to and selecting the desired file. Furthermore, file names displayed on taskbar buttons are typically truncated, making the buttons difficult to rapidly identify and select.

In view of the foregoing, what are needed are improved apparatus and methods for rapidly switching between applications displayed on a user's taskbar. Further needed are apparatus methods for hiding files and application that are used infrequently or have less relevance to the user.

### SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide an improved apparatus for interacting with open applications in a graphical-user-interface (GUI) environment. In one embodiment, such an apparatus includes an initiation module to initiate, at the prompting of a user, an application selection interface mimicking the standard taskbar of an operating system GUI. The application selection interface displays applications and files currently open on a computer system of the user. A customization module enables the user to hide, according to the user's preferences, specific files, applications, groups of files, menus, toolbars, and the like that are displayed on the application selection interface, while leaving displayed other files, applications, groups of files, menus, toolbars, and the like.

In certain embodiments, the apparatus includes a placement module to position the application selection interface at or near the vertical or horizontal position of a mouse pointer of the user. The apparatus may also include a display module to semi-transparently display the application selection interface, allowing the user to view graphical features behind the application selection interface. Similarly, the apparatus may include a “reveal all” module to display on the application selection interface all files and applications currently open on the user's computer system, including files grouped together under a single taskbar button. This “reveal all” module may, in certain embodiments, be configured to display the complete titles of all files and applications.

In another aspect of the invention, a method for interacting with open applications in a graphical-user-interface environment includes initiating, at the prompting of a user, an application selection interface mimicking the standard taskbar of an operating system GUI. The application selection interface displays applications and files currently open on a computer system of the user. The method further includes enabling the user to hide, in accordance with the user's preferences, at least one of specific files, applications, and groups of files displayed on the application selection interface, while leaving displayed the remaining open files, applications, and groups of files.

In selected embodiments, the method may further include positioning the application selection interface at or near the vertical or horizontal position of a mouse pointer of the user; semi-transparently displaying the application selection interface to enable the user to view graphical features behind the application selection interface; displaying on the application selection interface all files and applications currently open on the computer system, including files grouped together under a single taskbar button; and displaying the complete titles of all files and applications.

The present invention provides novel apparatus and methods for interacting with open applications in a GUI environment. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is an example of one embodiment of an application selection interface as it might appear in a WINDOWS environment;

FIG. 2 is an example of the application selection interface illustrated in FIG. 1 after various files and applications have been hidden from view;

FIG. 3 is an example of the application selection interface illustrated in FIG. 1 after selection of the “flatten all” option; and

FIG. 4 is a high-level block diagram showing one embodiment of various modules that may be used to implement an application selection interface in accordance with the invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details are provided, such as examples of programming, software modules, user selections, etc., to provide a thorough understanding of embodiments of the invention. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

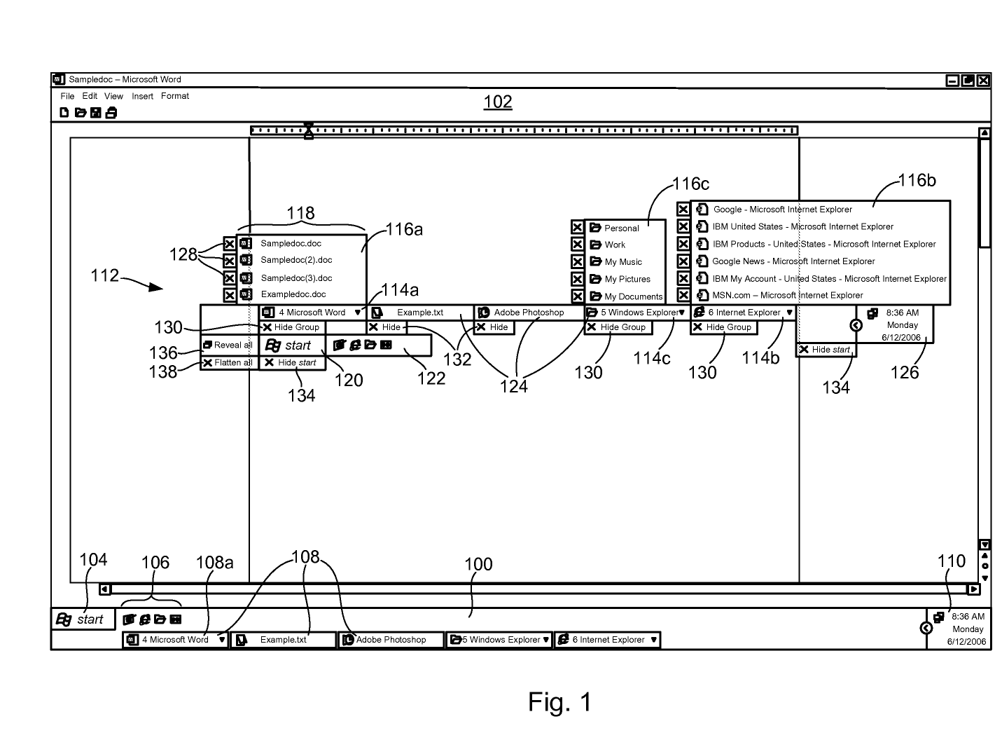

Referring to FIG. 1, as mentioned, the “taskbar” is the primary tool used to launch and monitor applications in the WINDOWS operating system. Other desktop environments, including but not limited to the LINUX and MAC operating systems, may provide similar features and elements to the WINDOWS taskbar. Thus, although particular reference is made to the WINDOWS taskbar herein, the principles disclosed herein may be readily applied to similar components and features in other operating systems. Thus, the term “taskbar” is not intended to limit the present invention to the WINDOWS environment, but is simply used as an example because of the ubiquitous nature of the WINDOWS operating system. Thus, the term “taskbar” used herein is used to mean not only the WINDOWS taskbar but also analogous components and elements in other operating systems and software.

As illustrated, a standard taskbar 100 is by default located at the bottom of a screen and may include a Start menu 104, Quick Launch bar 106, Taskbar buttons 108, and Notification area 110 which is also known as the system tray 110. Each time a file or application is opened, WINDOWS typically generates a new window 102 and corresponding button 108a in the taskbar 100. These buttons 108 enable the windows to be maximized, minimized, or made active, and provide for convenient monitoring of open files and applications. As new buttons 108 are created, the buttons 108 become narrower and text displayed on the buttons 108, typically a file or application name, is shortened and truncated.

The taskbar 100 often becomes crowded with taskbar buttons 108 when working with multiple applications simultaneously. To alleviate this problem, Microsoft introduced taskbar grouping. This feature groups several taskbar buttons 108 of the same application into a single button once a specified number of buttons 108, usually three, has been reached. For example, as shown in the taskbar 100, the button 108a represents a grouping of four Microsoft WORD documents. In general, a button 108a corresponding to several grouped files will include a number (e.g., “4”) corresponding to the number of files grouped and an arrow allowing the button 108a to be expanded to reveal each of the grouped files.

When a user desires to change the application displayed on his or her screen, the user must normally direct the mouse pointer to the bottom of the screen to select a button on the taskbar 100 or press alt+tab and then tab through the open applications until reaching a desired application. This process typically requires multiple mouse strokes and/or clicks or multiple key presses. Where taskbar buttons 108 are grouped together, a user must normally direct the pointer to the bottom of the screen, select the grouped button 108a, and scroll to and select the desired file. This process can be both arduous and time-consuming.

In certain embodiments, an application selection interface 112 in accordance with the invention may be provided to significantly improve a user's ability to navigate between open files and applications. In selected embodiments, an application selection interface 112 may be initiated or launched on the user's screen using a simple key stroke (e.g., quick key, function key, key combination, or the like), button, mouse click, or the like. Similarly, the application selection interface 112 may be configured to appear on the screen at the height of the user's mouse pointer. Thus, the application selection interface 112 may be directly beneath the user's mouse pointer to reduce the need to direct the pointer to the bottom of the screen, or to another screen if the user is employing multiple monitors.

In selected embodiments, the application selection interface 112 may “mimic” the standard taskbar 100 located at the bottom of the user's screen. Thus, the application selection interface 112 may be provided to the user in a format that a WINDOWS user is likely already familiar, thereby shortening the learning curve needed to operate the application selection interface 112. The term “mimic” is used herein to mean that the layout or appearance of the application selection interface 112 is similar to the layout or appearance of the standard taskbar 100, but does not necessarily replace the standard taskbar 100. Likewise, the term “mimic” may include replicating all or simply a portion of the standard taskbar 100. Thus, the application selection interface 112 may be configured to display one or more of a replicated Start menu 120, Quick Launch bar 122, Taskbar buttons 124, and Notification area 126.

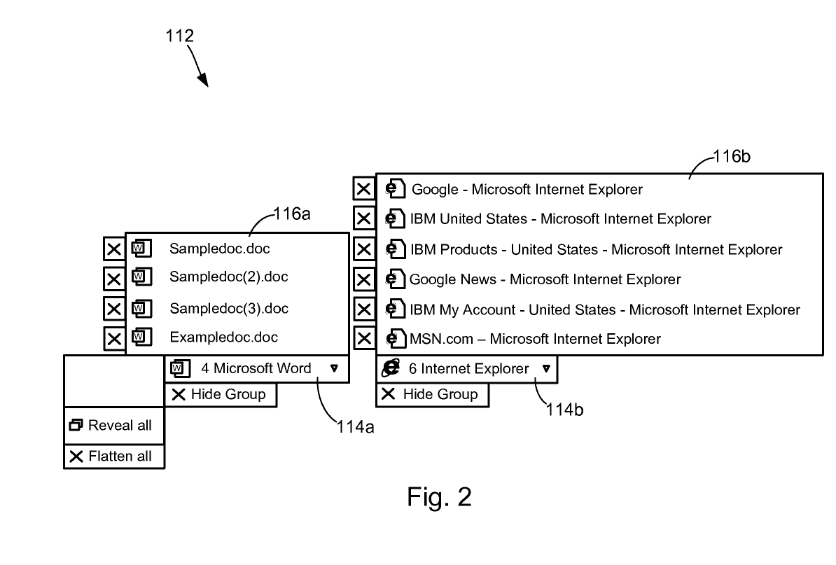

Upon launch, the application selection interface 112 may be configured to display a fully expanded view of all open applications and files, including those grouped together under single buttons 108a. For example, as illustrated, a button 114a corresponding to a specific application (e.g., Microsoft WORD) may reveal all files 116a opened in that application. This feature allows a user to quickly view all files and applications that are currently open without having to expand each grouped button 114a-c with the mouse pointer, as would be necessary with the standard taskbar 100. In certain embodiments, the application selection interface 112 may be configured to display complete, non-truncated filenames for each of the files 116a-c. This may be accomplished by widening the columns 118 sufficiently to display the full filenames or, alternatively, wrapping the text of the filenames to fit within the columns 118. In selected embodiments, the taskbar buttons 124 may also be spaced apart horizontally to make room for the complete filenames, as is shown in FIG. 2.

To aid in navigating or switching between different files or applications, the application selection interface 112 may be customized by a user. For example, the user may hide files, applications, or groups of files selected by the user, while leaving displayed other files, applications, or groups of files. In this way, a user may hide files, applications, or groups of files that are accessed infrequently or are irrelevant to a particular task, without having to close the application, files, or groups of files. Likewise, the user may modify the application selection interface 112 as needs change.

In certain embodiments, buttons 128 may be provided to hide particular files from view. Other buttons 130 may be used to hide groups of files from view, such as the group 116a. Other buttons 132 may be used to hide taskbar buttons, such as those corresponding to a file, application, or group of files. Yet other buttons 134 may be used to hide menus or toolbars from the application selection interface 112, such as the Start menu 120, Quick Launch bar 122, or Notification area 126. Thus, the application selection interface 112 may be tailored to the preferences and needs of a particular user.

In certain embodiments, the application selection interface 112 may include a “reveal all” button 136 and a “flatten all” button 138. The “reveal all” button 136 may be used to display all open files and application, including those that have been previously hidden from view. Similarly, the “flatten all” button 138 may be used to collapse expanded taskbar buttons 114a-c into grouped buttons. Thus, the “flatten all” button 138 may be used to hide the columns of files 116a-c, leaving only the grouped taskbar buttons 114a-c.

Although the application selection interface 112 may be customized, the standard taskbar 100 may retain its original functionality. Thus, although particular files, applications, or groups of files may be hidden on the application selection interface 112, they may still be accessed on the standard taskbar 100 in the conventional manner. In certain situations, the application selection interface 112 may be used for rapid switching between a user's most relevant files and applications while the standard taskbar 100 may be used as originally designed. Nevertheless, in other embodiments, it is contemplated that changes to the application selection interface 122 could also be automatically applied to the standard taskbar 100 to improve the speed and navigability of both.

FIG. 2 shows one example of the application selection interface 112 of FIG. 1 after various taskbar buttons 124 and files corresponding to the taskbar buttons 124 have been hidden. Thus, FIG. 2 shows one example of a customized application selection interface 112. Here, only the taskbar buttons 114a, 114b and the files 116a, 116b corresponding to each of these taskbar buttons 114a, 114b are displayed. The other taskbar buttons and files corresponding thereto have been hidden from view in the manner previously indicated.

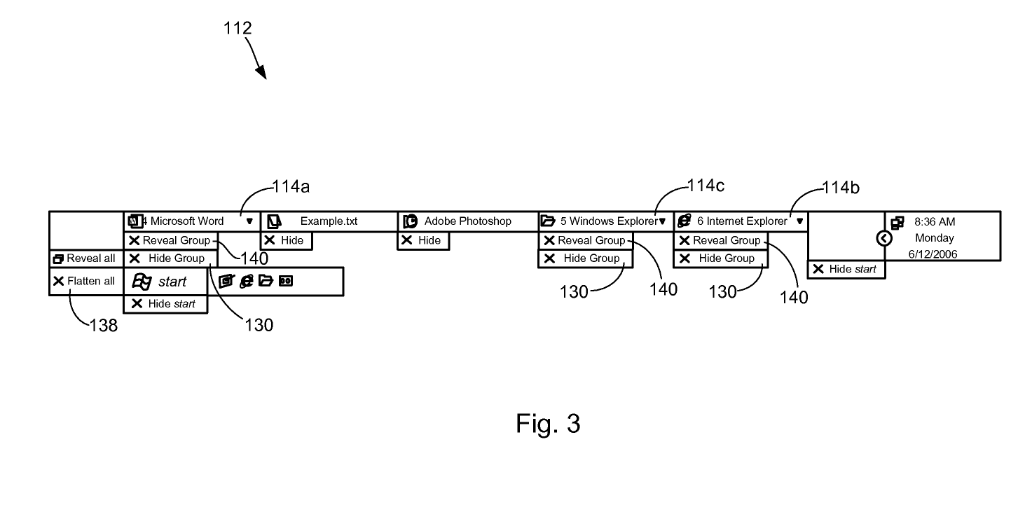

FIG. 3 shows one example of the application selection interface 112 of FIG. 1 after collapsing the taskbar with the “flatten all” button 138. As shown, each of the files 116a-c is hidden, leaving only the grouped taskbar buttons 114a-c. In certain embodiments, “reveal group” buttons 140 may appear after using the “flatten all” button 138 or “hide group” buttons 130. These buttons 140 may be used to reveal the files 116a-c corresponding to each grouped button 114a-c.

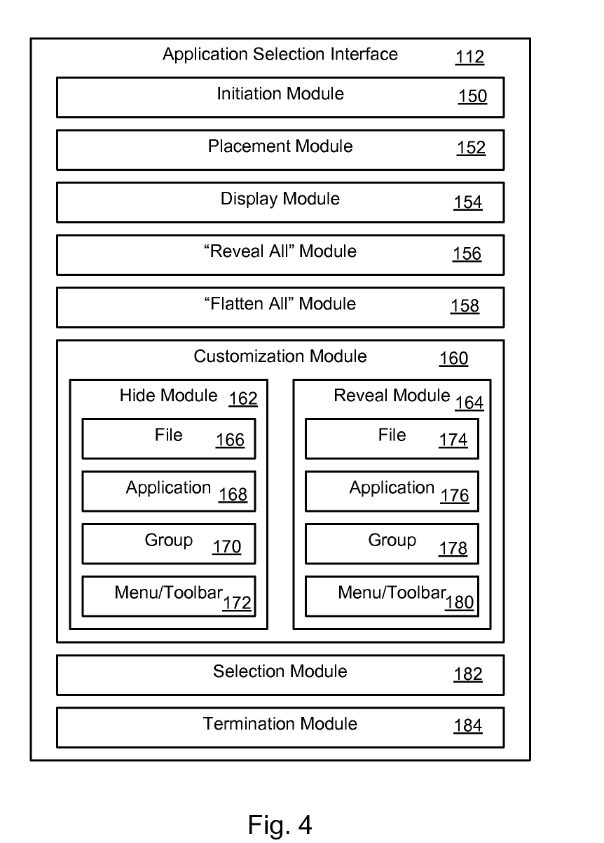

Referring to FIG. 4, in certain embodiments, an application selection interface 112 may include various modules embodied in software, hardware, firmware, or combinations thereof. For example, in one embodiment, an application selection interface 112 may include an initiation module 150 to launch the application selection interface 112 and thereby make it appear on the user's computer screen. As previously mentioned, this may be accomplished with a key stroke, such as a quick key, function key, or key combination, or by pressing a button, clicking the mouse, or the like. A placement module 152 may be used to position the application selection interface 112 on the user's screen. This may include determining the location of the user's mouse pointer vertically, horizontally or both in order to place the application selection interface 112 at a location that is convenient and easily accessible to the user's mouse.

A display module 154 may be used to display the application selection interface 112 on the user's screen in a format mimicking all or part of the standard taskbar 100 and to modify it each time it is changed or customized by the user. The display module 154 may also be used to semi-transparently display the application selection interface 112 so that graphical features, such as windows displayed on the user's screen, are visible through the application selection interface 112.

A “reveal all” module 156 may be used to reveal all application and files that are currently open on the user's computer as previous discussed. Similarly, a “flatten all” module 158 may be used to hide groups of files opened with the same application under grouped taskbar buttons. A customization module 160 may be used to tailor the application selection interface 112 to the preferences or needs of a particular user. For example, the customization module 160 may include a hide module 162 for hiding selected files 166, applications 168, groups 170 of files, menus 172 (e.g., Start menu, Notification Area) or toolbars 172 (e.g., Quick Launch bar). Similarly, a reveal module 164 may be used to reveal selected files 174, applications 176, groups 178 of files, menus 180, or toolbars 180.

A selection module 182 may be used to change the active window on the user's screen based on the user's selection of a file or application on the application selection interface 112. A termination module 184 may be used to hide the entire application selection interface 112 from the user's screen until launched again with the initiation module 150. Similarly, the application selection interface 112 may include other modules as needed to provide additional functionality. For example, any or all of the features, including those not mentioned herein, provided by the standard taskbar 100 may also be incorporated into and provided by the application selection interface 112 as needed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for interacting with open applications in a graphical-user-interface (GUI) environment, the apparatus comprising:
an initiation module to initiate, at the prompting of a user, an application selection interface mimicking the standard taskbar of an operating system GUI, the application selection interface displaying applications and files currently open on a computer system of the user; and
a customization module enabling the user to hide, in accordance with the user's preferences, at least one of specific files, applications, and groups of files displayed on the application selection interface, while leaving displayed the remaining open files, applications, and groups of files.

2. The apparatus of claim 1, further comprising a placement module to position the application selection interface proximate at least one of a vertical and horizontal position of a mouse pointer of the user.

3. The apparatus of claim 1, further comprising a display module to semi-transparently display the application selection interface, allowing the user to view graphical features behind the application selection interface.

4. The apparatus of claim 1, further comprising a “reveal all” module to display on the application selection interface all files and applications currently open on the computer system, including files grouped together under a single taskbar button.

5. The apparatus of claim 4, wherein the “reveal all” module is further configured to display the complete titles of all files and applications.

6. A method for interacting with open applications in a graphical-user-interface environment, the method comprising:
initiating, at the prompting of a user, an application selection interface mimicking the standard taskbar of an operating system GUI, the application selection interface displaying applications and files currently open on a computer system of the user; and
enabling the user to hide, in accordance with the user's preferences, at least one of specific files, applications, and groups of files displayed on the application selection interface, while leaving displayed the remaining open files, applications, and groups of files.

7. The method of claim 6, further comprising positioning the application selection interface proximate at least one of a vertical and horizontal position of a mouse pointer of the user.

8. The method of claim 6, further comprising semi-transparently displaying the application selection interface, allowing the user to view graphical features behind the application selection interface.

9. The method of claim 6, further comprising displaying on the application selection interface all files and applications currently open on the computer system, including files grouped together under a single taskbar button.

10. The method of claim 9, further comprising displaying the complete titles of files and applications.
